(19) United States
(12) Patent Application Publication
(10) Pub. No.: US 2026/0107333 A1
(43) Pub. Date: Apr. 16, 2026

(54) INFERRED PAIRING FOR TRACKING DEVICES

(71) Applicant: CHORUSVIEW, INC., Las Vegas, NV (US)

(72) Inventors: Xuejing Jiao, Austin, TX (US); Peikeng Chen, Los Altos, CA (US); Peter Mehring, Los Altos, CA (US); Bin He, Los Altos, CA (US); Quentin Truong, Sunnyvale, CA (US); Fangfang Sheng, Lafayette, CO (US)

(21) Appl. No.: 19/335,072

(22) Filed: Sep. 22, 2025

Related U.S. Application Data
(60) Provisional application No. 63/707,513, filed on Oct. 15, 2024.

(51) Int. Cl. H04W 76/10; H04W 4/021; H04W 48/16; H04W 72/40

(52) U.S. Cl. CPC H04W 76/10; H04W 4/021; H04W 48/16; H04W 72/40

(57) ABSTRACT

Aspects of the disclosure provide for inferred pairing of objects and/or tracking devices to trips. For example, information associated with a first beacon signal generated by a first tracking device attached to a first object may be received from a first reader device. One or more reader devices that received any beacon signal generated by the first tracking device within a period of time may be identified. A second tracking device for which a second beacon signal was received by the identified one or more reader devices within the period of time may be identified. This second tracing device may be attached to a second object. In response to identifying the second tracking device, the second tracking device may be associated with a trip in order to track the second tracking device while the second object and the first object are on the trip.

### CROSS REFERENCE TO RELATED APPLICATIONS

The present application claims the benefit of the filing date of U.S. Provisional Application No. 63/707,513, filed Oct. 15, 2024, the entire disclosure of which is incorporated by reference herein.

### BACKGROUND

The Internet of Things (IoT) is the inter-networking of physical objects, such as products, packages, vehicles, buildings, etc., that are embedded with electronic components for network connectivity. The embedded components enable objects to detect others, be detected by others, collect data and/or transmit data. In some examples, the embedded components may include tags or labels attached to the physical objects. These tags or labels may be passive or active. The inter-networking capabilities may be leveraged for tracking locations of physical objects. In many situations, objects may be moved at different points in time, such as a package or equipment moved from a truck to a loading dock to a warehouse, or medical equipment that is moved between different rooms (or floors) in a hospital.

In some instances tracking devices may be “paired” with assets or objects to which the tracking devices will or are attached. Pairing may involve creating a relationship between the object and the tracking device such that beacon signals sent by the tracking device can be automatically associated with the object. Once paired with an object, the tracking device may be used to track the object. In some systems, tracking devices, and therefore objects, may also be paired to “trips” (“trip pairing”), that is, an object may be assigned to a trip to a destination. This may enable the tracking of the object during the trip. Typically, trip pairing is a labor intensive and manual effort which requires scanning individual labels of the tracking devices and assigning each individual tracking device (or object) to a trip.

### BRIEF SUMMARY

Aspects of the disclosure provide a method. The method includes receiving, by one or more processors of one or more server computing devices and from a first reader device, information associated with a first beacon signal generated by a first tracking device attached to a first object; identifying, by the one or more processors, one or more reader devices that received any beacon signal generated by the first tracking device within a period of time; identifying, by the one or more processors, a second tracking device for which a second beacon signal was received by the identified one or more reader devices within the period of time, the second tracing device being attached to a second object; and in response to identifying the second tracking device, associating, by the one or more tracking devices, the second tracking device with a trip in order to track the second tracking device while the second object and the first object are on the trip.

In one example, when the information associated with the first beacon signal is received, the first tracking device is associated with the trip, and wherein associating the second tracking device with the trip is based on the association of the first tracking device with the trip. In another example, the identified one or more reader devices include the first reader device and the second beacon signal is received by the first reader device. In another example, the second beacon signal is received by a reader device other than the first reader device. In another example, the method also includes determining when the first tracking device has left a geographic area, and wherein identifying the identified one or more reader devices is in response to determining that the first object has left the geographic area. In another example, the method also includes determining when the first tracking device been outside of a geographic area for at least a second period of time, and wherein identifying the identified one or more reader devices is in response to determining that the first object has been outside of a geographic area for at least a second period of time. In another example, the method also includes, in response to identifying the second tracking device, determining a similarity score for the second tracking device and the first tracking device, and wherein associating the second tracking device with the trip is based on the similarity score. In this example, the similarity score is determined further based on all beacon signals generated by the first tracking device and the second tracking device received by reader devices within the period of time. In addition, the method also includes, associating, by the one or more tracking devices, the first tracking device with the trip based on the similarity score in order to track the first tracking device while the first object is on the trip. In addition, or alternatively, the method also includes clustering the similarity score with other similarity scores in order to identify a plurality of tracking devices including the first tracking device and the second tracking device, and wherein associating the second tracking device with the trip includes associating each of the plurality of tracking devices with the trip.

Another aspect of the disclosure provides a system. The system includes one or more server computing devices having one or more processors configured to: receive, from a first reader device, information associated with a first beacon signal generated by a first tracking device attached to a first object; identify one or more reader devices that received any beacon signal generated by the first tracking device within a period of time; identify a second tracking device for which a second beacon signal was received by the identified one or more reader devices within the period of time, the second tracing device being attached to a second object; and in response to identifying the second tracking device, associate the second tracking device with a trip in order to track the second tracking device while the second object and the first object are on the trip.

In one example, when the information associated with the first beacon signal is received, the first tracking device is associated with the trip, and wherein the one or more processors are further configured to associate the second tracking device with the trip further based on the association of the first tracking device with the trip. In another example, the system also includes the identified one or more reader devices, and the identified one or more reader devices include the first reader device, and wherein the first reader device is configured to receive the second beacon signal. In another example, the system also includes the first tracking device and the second tracking device. In another example, the one or more processors are further configured to determine when the first tracking device has left a geographic area and to identify the identified one or more reader devices in response to determining that the first object has left the geographic area. In another example, the one or more processors are further configured to determine when the first tracking device been outside of a geographic area for at least a second period of time, and to identify the identified one or more reader devices in response to determining that the first object has been outside of a geographic area for at least a second period of time. In another example, the one or more processors are further configured to, in response to identifying the second tracking device, determine a similarity score for the second tracking device and the first tracking device, and to associate the second tracking device with the trip further based on the similarity score. In another example, the one or more processors are further configured to determine the similarity score further based on all beacon signals generated by the first tracking device and the second tracking device received by reader devices within the period of time. In this example, the one or more processors are further configured to associate the first tracking device with the trip based on the similarity score in order to track the first tracking device while the first object is on the trip. In addition, or alternatively, the one or more processors are further configured to cluster the similarity score with other similarity scores in order to identify a plurality of tracking devices including the first tracking device and the second tracking device, and wherein the one or more processors are further configured to associate each of the plurality of tracking devices with the trip.

### BRIEF DESCRIPTION OF THE DRAWINGS

FIG. 1A illustrates various examples for localization of objects in accordance with aspects of the technology.

FIG. 1B is a functional diagram of an example tracking system in accordance with aspects of the disclosure.

FIG. 2 is a pictorial diagram of an example network in accordance with aspects of the disclosure.

FIG. 3 is a functional diagram of the example network in FIG. 2 in accordance with aspects of the disclosure.

FIGS. 4A-B illustrate example scenarios in accordance with aspects of the disclosure.

FIGS. 5A-B are example views of tracking devices in accordance with aspects of the disclosure.

FIGS. 6A-B are example views of tracking device in accordance with aspects of the disclosure.

FIG. 7 is an example representation of beacon signals and associated data in accordance with aspects of the disclosure.

FIG. 8 is an example representation of beacon signals and associated data in accordance with aspects of the disclosure.

FIG. 9 is an example flow diagram in accordance with aspects of the disclosure.

### DETAILED DESCRIPTION

### Overview

The technology relates to inferred pairing of objects in systems for tracking those objects. As noted above, tracking devices may be “paired” with assets or objects to which the tracking devices will or are attached. Pairing may involve creating a relationship between the object and the tracking device such that beacon signals sent by the tracking device can be automatically associated with the object. Once paired with an object, the tracking device may be used to track the object. In some systems, tracking devices and therefore objects may also be paired to “trips” (“trip pairing”), that is, an object may be assigned to a trip to a destination. This may enable the tracking of the object during the trip. Typically, trip pairing is a labor intensive and manual effort which requires scanning individual labels of the tracking devices and assigning each individual tracking device (or object) to a trip. To address these deficiencies, at least some trip pairing may be automatically inferred to improve efficiency and potentially significantly reduce manual effort.

In a tracking system, a tracking device may include circuitry that enables the tracking device to periodically send beacon signals. When a beacon signal is sent by a tracking device, it may be received or “heard” by a reader device. Each beacon signal may include information about the tracking device, for example, a tracking device identifier (ID), sensor data generated by one or more sensors of the tracking device, a timestamp for the sensor data, etc.

A reader device may be a computing device configured to detect the beacon signals emitted by tracking devices. For instance, reader devices may be hand-held scanning devices, tablets, cell phones, etc. The reader device may process and/or relay information from the beacon signals to one or more server computing devices which enables the processing and analysis of that information, for example, to determine a location of the tracking device and the associated object.

In some instances, an operator may scan a barcode, QR code, or other visual feature of a first tracking device in order to identify the first tracking device. The operation may then select a trip, for instance from a plurality of predefined trips, and assign that tracking device and/or its associated object to the selected trip.

The first tracking device as well as a plurality of other tracking devices may periodically send beacon signals as described above. These may be received by one or more reader devices and information from the beacon signals may be reported or sent to and received by the server computing devices. This information may include, for example, any sensor data, timestamps, or other messages (e.g., alerts) in the beacon signals as well as information identifying the tracking device.

The server computing devices may receive the information for a beacon signal of the first tracking device and associate the information with an identifier for the reader device that sent the information. The information and the association may be stored for later use and retrieval. Using the tracking device ID and timestamp, the server computing devices may identify any reader devices that have also received the beacon signal of the first tracking device within a predetermined window or period of time.

For any identified reader devices, the server computing devices may also identify any other tracking devices from which those reader devices also received beacon signals within the time window. For any other tracking devices that are identified, the server computing devices may automatically associate those other tracking devices and any associated objects of those tracking devices with the trip. In addition, the same approach can be used to attach additional attributes to those other tracking devices and any associated objects of those tracking devices rather than having to do so individually.

Various approaches may also be used to reduce and potentially eliminate false positives. For instance, the server computing devices may only search for other reader devices and other tracking devices in certain situations. In other instances, in order to reduce and potentially eliminate false positives, before assigning other tracking devices to the trip, the server computing devices may calculate similarity scores. Tracking devices that are traveling on the same trip are likely to have very high similarity scores.

While the example above involves a first tracking device which is initially assigned to a trip, in some instances, this step may not occur or be possible. In such instances, the server computing devices may periodically process beacon signals from all tracking devices or all tracking devices that are not currently assigned to a trip. When a beacon signal for that tracking device is received, the server computing devices may then identify any other reader devices that have also received the beacon signal within the predetermined period of time. Again, for any identified reader devices, the server computing devices may also identify any other tracking devices from which those reader devices also received beacon signals within the time window. The server computing devices may then calculate trajectory similarity scores between any two tracking devices as described above. The server computing devices may then use a clustering algorithm to identify which tracking devices should be assigned to the same trip.

The features described herein provide for inferred pairing of objects and/or tracking devices to trips. In particular, trip pairing may be automatically inferred to improve efficiency and potentially significantly reduce manual effort. In addition, the feature described herein may provide for better and more useful inventory management as described above.

### Example Systems

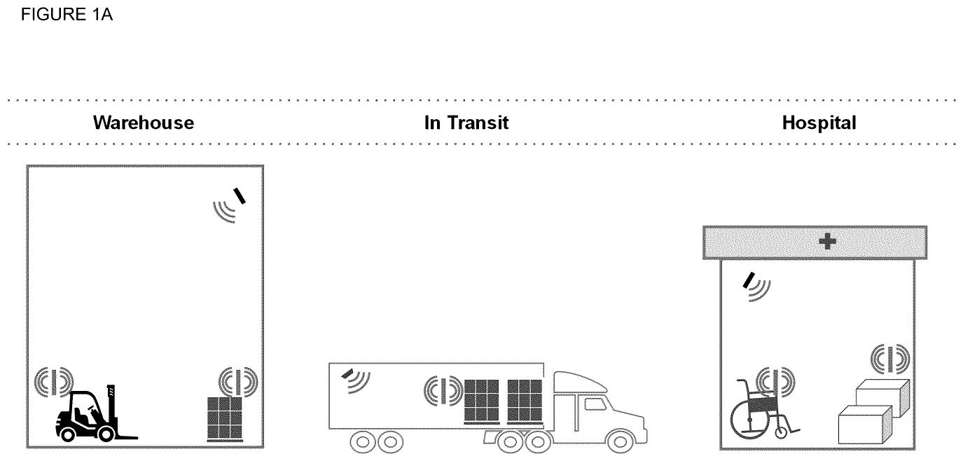

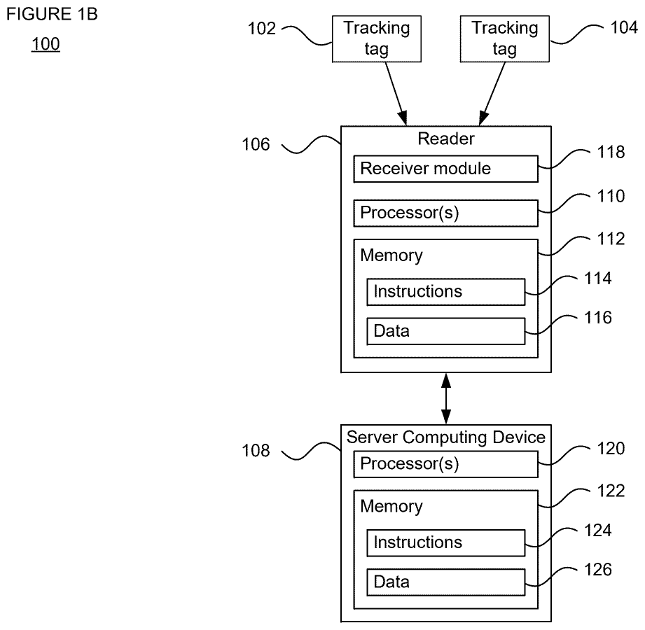

FIG. 1A illustrates examples of different objects in various environments. As shown on the left side image of the figure, there may be packages or equipment on a pallet in a warehouse. The pallet may have come off of a cargo truck as shown by the “In Transit” image in the middle of the figure. The pallet may be moved to one or more different locations within a warehouse, such as by the forklift shown in the left side image. The right-side image in the figure illustrates a situation where medical equipment (e.g., a wheelchair) and supplies in boxes may be stored in a supply room in a hospital.

In all of these situations-in the warehouse, on the cargo truck, or at the hospital, the objects of interest may move around. That may be to a different aisle or room in the warehouse, a different room (or even a different floor) of the hospital, or different part of the cargo container of the truck. In the latter case, the cargo may have shifted during transit or may have been repositioned as different packages were delivered to different locations. Knowing where the objects of interest are currently located, as opposed to where they are presumed to be based on an initial placement, is a valuable piece of information for an office manager, warehouse manager, nurse or orderly to have. Ideally, such people should be able to get the current location of a given object on their client computing device such as a laptop, mobile phone or smartwatch.

FIG. 1B is a functional diagram of a tracking system 100. The tracking system 100 may include a plurality of tracking devices, such as tracking devices 102 and 104, and a reader devices 106. As discussed further below, one or more server computing devices 108 may also be part of the tracking system 100. A given tracking device may be placed on or otherwise attached to or inserted into an object to be tracked, such as a package, a piece of equipment, a vehicle, a warehouse section, a room, etc. While tracking devices 102 may be associated with objects such as packages, equipment or vehicles (e.g., a forklift or an autonomous fulfillment robot that can retrieve packages from different locations in a warehouse), tracking devices 104 may be fixed to an aisle in a warehouse or from a specific room in a hospital. Thus, different tracking devices may be used depending upon customer needs. As an example, different customers may have varying accuracy and “liveliness” needs. For instance, one customer may only want to know aisle-level accuracy every day (e.g., before a warehouse closes for the evening), while another customer such as a hospital nurse may need to know which room a piece of equipment is in every hour so that it can be accessed should a patient need such equipment. Each tracking device 102 or 104 may emit an informational signal, for example a beacon signal, via an antenna, such as using the transmitting device, to communicate data. In this regard, each tracking device may include an identifier chip (such as for radiofrequency (RF) identification) and/or a transmitting device (such as an RF module configured to transmit beacon signals using a selected frequency band and transmission protocol). In this regard, the beacon signals may simply transmit identifying information in order to enable tracking of objects in the case of tracking devices discussed further below. To facilitate this, each tracking device may be embedded with a unique identifier, such as a unique MAC address or BLUETOOTH identifier, which may function as a tracking device identifier. This tracking device identifier may be assigned to the tracking device during the manufacturing or provisioning processes (described further below).

The transmitting device may send such information via radio frequency transmission in a selected frequency band, using a standard or proprietary protocol. By way of example, the transmitting device may employ a BLUETOOTH (e.g., a BLUETOOTH Low Energy (BLE)) or 802.11 protocol in the 2.4 GHz and/or 5 GHz frequency bands. In some examples, each beacon tracking device and each tracking device uses the BLUETOOTH or BLE protocol.

In some instances, the tracking devices may include one or more sensors. In such instances, the aforementioned communicated data may be formatted according to the selected protocol and include one or more sensed characteristics of the given tracking device or its environment. For example, the sensed characteristic may be a temperature, a location, motion, battery conditions, trip conditions, and/or other detectable characteristics of the tracking devices or its environment.

The reader devices 106 may be a computing device configured to detect the beacon signals emitted by the plurality of tracking devices 102 and 104, then store and/or transmit data related to the tracking devices. For instance, reader devices may be hand-held scanning devices, tablets, cell phones, WiFi access points, etc. While only one reader device is shown in FIG. 1B, the system may employ multiple reader devices. The reader devices 106 may include one or more processors 110, memory 112 and other components typically present in general purpose computing devices. The reader devices 106 includes a receive module 118 having an antenna and a processing section (not shown), which may include a bandpass filter for the frequency band of interest, an analog to digital (A/D) converter, and a signal processing module to evaluate information in received beacon signals. The processing section may also convert the received beacon signal to a baseband signal, before or after A/D conversion.

The one or more processors 110 may be any conventional processors, such as commercially available CPUs or microcontrollers. Alternatively, the one or more processors may be a dedicated device such as an ASIC or other hardware-based processor, such as a field programmable gate array (FPGA). Although FIG. 1B functionally illustrates the one or more processors, memory, and other elements of the reader devices 106 as being within the same block, the processor, computing device, or memory may actually include multiple processors, computing devices, or memories that may or may not be stored within the same physical housing. For example, memory may be a hard drive, a removable USB drive or other storage media located in a housing different from that of the reader devices 106. Accordingly, references to a processor or computing device will be understood to include references to a collection of processors or computing devices or memories that may or may not operate in parallel.

The memory 112 stores information accessible by the one or more processors 110, including instructions 114 and data 116 that may be executed or otherwise used by the one or more processors 110. The data may include sensed characteristics from any of the tracking devices 102 and/or 104 received by the reader devices 106. The memory 112 may be of any type capable of storing information accessible by the one or more processors, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The data 116 may be retrieved, stored or modified by the one or more processors 110 in accordance with the instructions 114. For instance, although the claimed subject matter is not limited by any particular data structure, the data may be stored in computing device registers, in a relational database as a table having a plurality of different fields and records, 8ML documents or flat files. The data may also be formatted in any computing device-readable format.

The instructions 114 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

In some implementations, the tracking system 100 may further include a central server, such as one or more server computing devices 108 accessible by the one or more processors 110 of the reader devices 106. In some implementations, one or more tracking devices in the tracking system 100, such as a tracking device 104, may be configured to obtain and communicate data directly to the one or more server computing devices 108. The one or more server computing devices 108 may include one or more processors 120, memory 122 and other components typically present in general purpose computing devices. The one or more processors 120 may be the same or similar type as the one or more processors 110, and the memory 122 may be the same or similar type as the memory 112. The memory 122 stores information accessible by the one or more processors 120, including instructions 124 and data 126 that may be executed or otherwise used by the one or more processors 120. Data 126 and instructions 124 may be the same or similar type as the data 116 and instructions 114, respectively.

After detecting the beacon signals of one or more tracking devices 102 or 104, the reader devices 106 may transmit the data from the tracking devices to the one or more server computing devices 108 through an existing connection or through a network. Thus, in this case the reader devices 106 may include a transmitter module (not shown) that is configured for wired or wireless transmission to the server computing device. The data may be received in a series of payloads (e.g., data packets) either continually, at one or more set intervals, or ad hoc whenever the tracking devices transmit. Thus, when there are multiple tracking devices, the data is effectively received as a plurality of separate data streams. A given payload (which may comprise one or more data packets) may include measurements taken at one or more time intervals, each of which may have a corresponding timestamp. In one scenario, the reader devices 106 may include a transceiver including both a receiver and a transmitter, which is configured to receive beacon signals from the tracking devices 102 and 104 and also to send and receive information with the server computing devices 108.

The one or more server computing devices 108 may be configured to track characteristics of the tracking devices for one or more alerts based on a plurality of conditions. The plurality of conditions may include at least one condition for each characteristic, such as a minimum, a maximum, a threshold, a duration, or a geofence. The conditions may be predetermined or set based on user input. For example, a first alert may be set for when (1) a temperature is greater than, e.g., 0° C. to 11° C. for 30 minutes and (2) the tracking device is on a trip, which may indicate overheating of a cooled package or storage compartment. A second alert may be set for when (1) no motion is detected for 11 minutes, (2) 2 of 3 locations are in a geofence, and (3) the tracking device is on a trip, which may indicate that a package is out for delivery. A third alert may be set for when (1) a threshold amount of light is detected from inside a package and (2) the tracking device is on a trip, which may indicate unexpected opening of the package or tampering. A fourth alert may be set for when (1) a threshold amount of light is detected from inside a package and (2) 2 of 3 locations are in a destination geofence, which may indicate opening of the package after delivery or receipt. Many other alert conditions and tracking scenarios are possible, and the above examples are not intended to be limiting.

The tracking system 100 may optionally include an application that may be installed on one or more client computing devices. Using the application, the client computing devices may access the data from the reader devices 106 and/or the server computing devices 108 through a network.

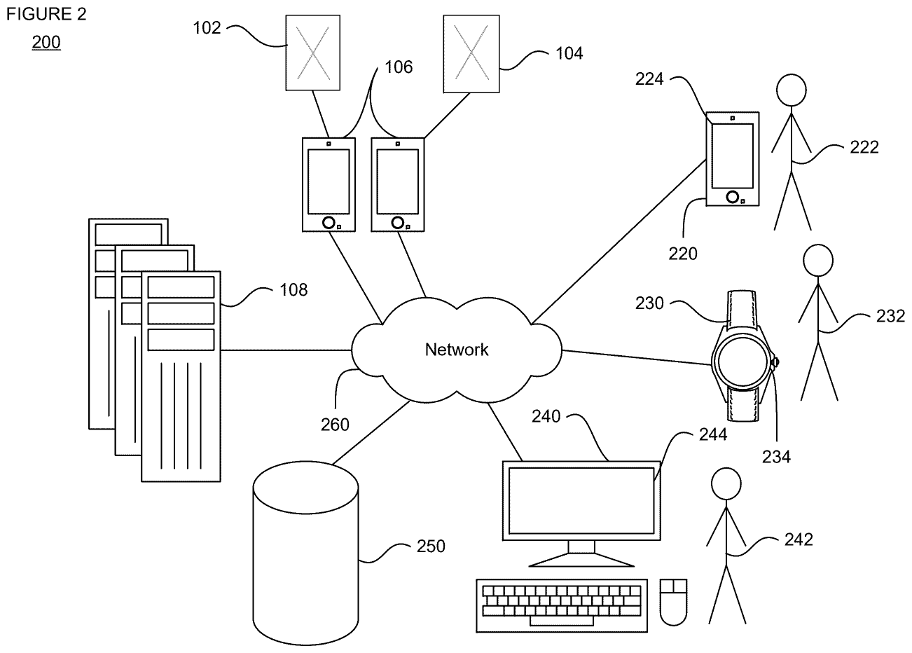

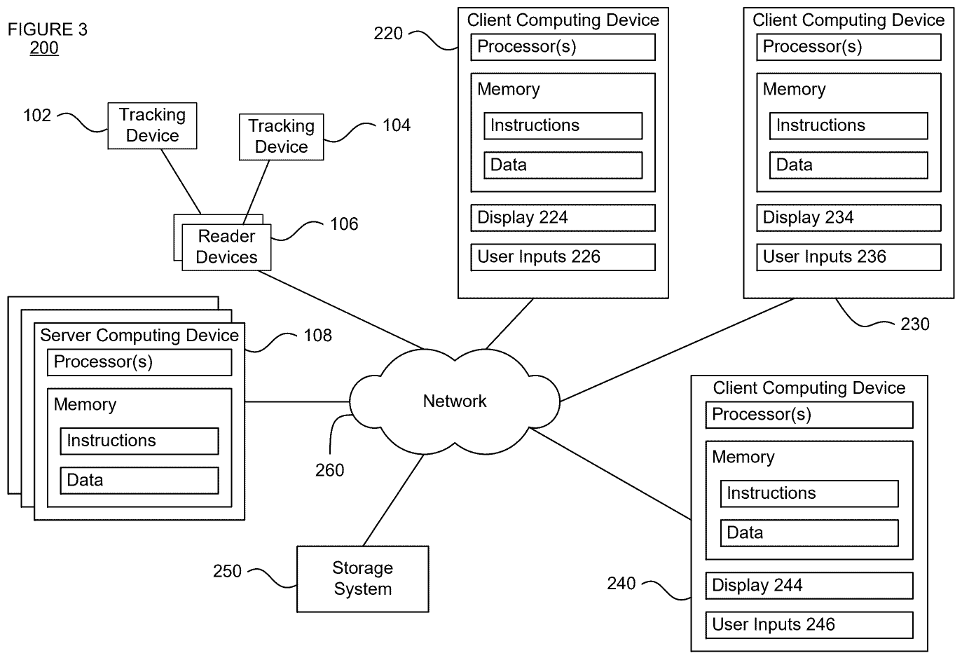

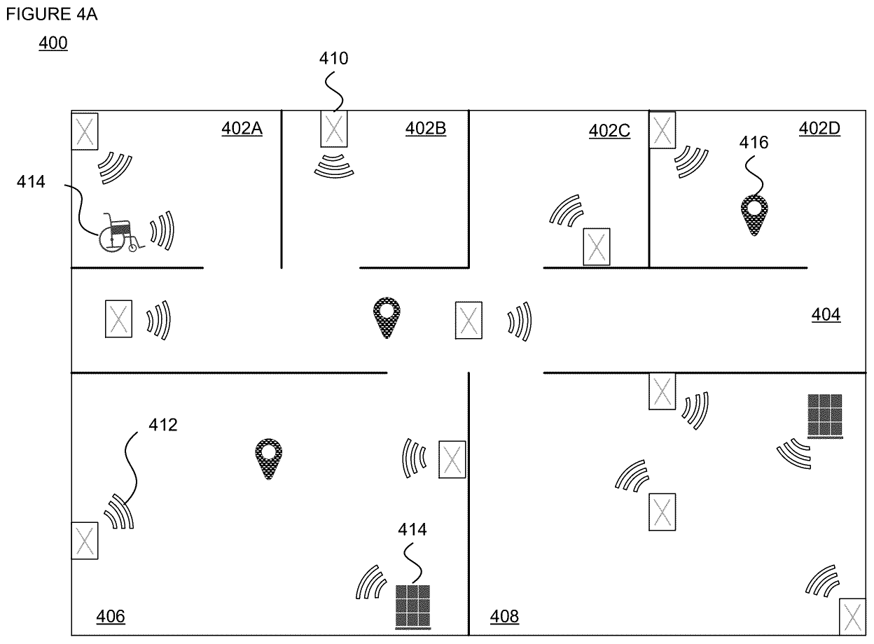

FIGS. 2 and 3 are pictorial and functional diagrams, respectively, of an example system 200 that includes a plurality of client computing devices 220, 230, 240 and a storage system 250 connected via a network 260. System 200 also includes tracking system 100, including tracking devices 102, 104, reader devices 106, and server computing device 108. Although only a few tracking devices, reader devices, and computing devices are depicted for simplicity, a typical system may include significantly more.

The network 260, and intervening nodes, may include various configurations and protocols including short range communication protocols such as BLUETOOTH, BLUETOOTH LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Using the client computing devices, users, such as user 222, 232, 242, may view the location data on a display, such as displays 224, 234, 244 of respective client computing devices 220, 230, 240. As shown in FIG. 3, each client computing device 220, 230, 240 may be a personal computing device intended for use by a respective user and have all of the components normally used in connection with a personal computing device including one or more processors (e.g., a central processing unit (CPU)), memory (e.g., RAM and internal hard drives) storing data and instructions, a display such as displays 224, 234, 244 (e.g., a monitor having a screen, a touch-screen, a head-mounted display, a smartwatch display, a projector, a television, or other device that is operable to display information), and user input devices 226, 236, 246 (e.g., one or more of a mouse, keyboard, touch screen and/or a microphone). The client computing devices may also include speakers, a network interface device, and all of the components used for connecting these elements to one another.

Although the client computing devices 220, 230, and 240 may each comprise a full-sized personal computing device, they may alternatively comprise mobile computing devices capable of wirelessly exchanging data with a server over a network such as the Internet. By way of example only, client computing device 220 may be a mobile phone or a device such as a wireless-enabled PDA, a tablet PC, a wearable computing device or system (e.g., a smartwatch or head-mounted display), or a netbook that is capable of obtaining information via the Internet or other networks. As an example, the user may input information using a small keyboard, a keypad, microphone, using visual signals (gestures) with a camera or other sensor, or a touch screen.

As with memory 112, storage system 250 can be of any type of computerized storage capable of storing information accessible by the one or more server computing devices 108, such as a hard-drive, memory card, ROM, RAM, DVD, CD-ROM, write-capable, and read-only memories. In addition, storage system 250 may include a distributed storage system where data is stored on a plurality of different storage devices which may be physically located at the same or different geographic locations. Storage system 250 may be connected to the computing devices via the network 260 as shown in FIG. 2, and/or may be directly connected to or incorporated into any of the client computing devices 220, 230, 240. The storage system 250 may store information about the tracking devices including, for example, location, status (e.g., activated and when), identifiers, last update, sensor data (e.g., temperature measurements), information about the object to which the tracking device is attached (e.g., manufacturing data), timestamps, trips, reader devices that received the beacon signals, and so on. In this regard, the information may be determined from received beacon signals provided to and updated at the storage system 250 by any of the one or more server computing devices 108 and/or client computing devices 220, 230, 240.

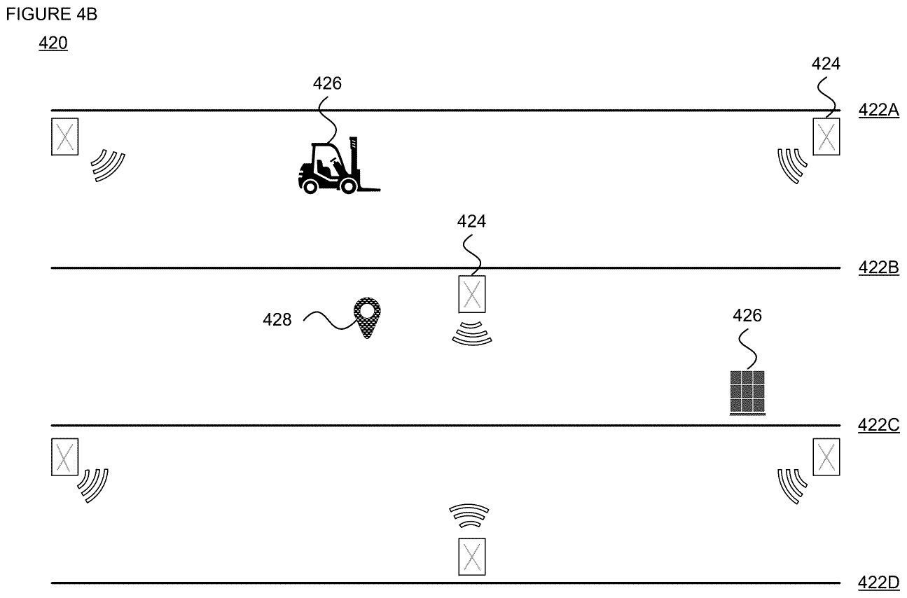

FIG. 4A illustrates one example 400 of a system having a number of tracking devices arranged in various locations of a building (e.g., a hospital). In this example, there may be a number of rooms 402A-402D, such as patient rooms, along one side of a hallway 404. On the opposite side of the hallway 404 there is a storage room 406, such as to house equipment or supplies, as well as another room 408, which may be a meeting room, common area, rehab facility or the like. One or more fixed tracking devices 410 corresponding to the tracking devices 102 or 104 may be located in each room, including the hallway. Each fixed tracking device 410 is configured to emit beacon signals 412 (e.g., RF signals in a selected frequency band according to a particular communication protocol). While the beacon signals 412 may appear directional, this need not be the case and the beacon signals may be transmitted omnidirectionally, for instance from a tracking device 410 that is located on the ceiling, pillar or floor. In some implementations, the tracking device 410 may be configured to emit beacon signals with information associated with its environment (e.g., temperature, humidity, etc.).

Tracking devices 414 may correspond to tracking devices 102 or 104 when placed on a variety of objects (e.g., a case of supplies as shown in storage room 406 or a wheelchair shown in room 402A). In some instances, the tracking devices may also be configured to emit beacon signals with information associated with the object on which the tracking device is applied (e.g., temperature, motion information, object details, and/or other detectable characteristics of the tracking device or its environment). Reader devices 416 may be found at various locations in the building, such as in a patient room, the storage room, the hallway or other location. Note that even if transmitted omnidirectionally, the beacon signals from a given tracking device may be attenuated in a non-uniform manner due to the presence of walls, furniture, floors/ceilings, equipment, etc.

FIG. 4B illustrates another example 420 of a system having a number of fixed tracking devices positioned along different aisles in a warehouse setting. In this example, there are a number of aisles 422A-422D, although there may be more (or fewer) aisles, and the aisles may be arranged in other configurations than what is shown. Here, fixed tracking devices 424 are located at different places for the aisles, such as along aisle end caps, along the ceiling (or floor), on shelves, storage lockers, cabinets or other places along the aisle, etc. Similar to FIG. 4A, fixed tracking devices 426 are placed on or otherwise associated with different objects, such as a pallet of equipment or a forklift that retrieves items from their locations in the warehouse. As above, the fixed tracking devices are configured to transmit beacon signals that are detectable by one or more reader devices 428.

In order to determine the location of a given tracking device, the system may use signal strength information obtained from the beacon signals of one or more tracking devices. A series of beacon signals may be ramped at different power levels (a ramped sequence). Evaluating the received beacon signals in view of their transmitted power can enable the system to determine which room or other location at which a given tracking device is located. From that, the system is able to determine a location for a given tracking device (and thus its corresponding object) with a suitable degree of certainty, such as by triangulating its position relative to the relevant tracking devices.

In order to enable the use of the aforementioned tracking devices on as many different types of objects and locations as possible, the tracking devices may be designed to be both thin and flexible. In addition, each tracking device may be passive, such as a tracking device configured to activate or be powered by environmental energy, or active, configured to include a battery or be coupled to another power source. In the case of a battery, delaying activation of the battery until the end user is ready to use the tracking device is critical to extending the useful life of the tracking device.

In order to enable the use of the aforementioned tracking devices on as many different types of articles to be shipped and other objects as possible, the tracking devices may be designed to be both thin and flexible. In this regard, the tracking devices may be configured as tracking “tags” or adhesive shipping labels (e.g., 4×6 shipping labels commonly used by logistics companies to ship packages such as envelopes, boxes, bags, etc.).

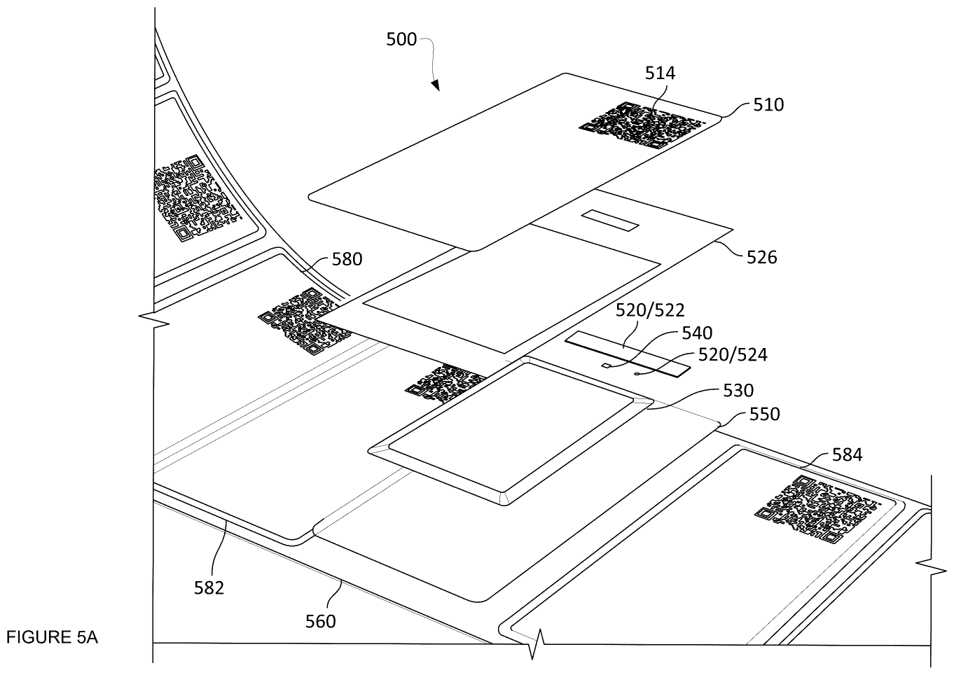

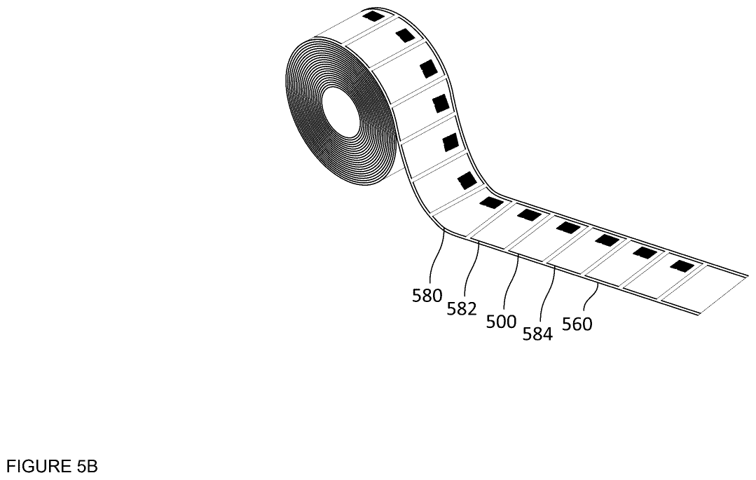

Each tracking device may include various components such as a top layer for printing a label, a frame, beacon transmission circuitry, a bottom layer including an adhesive (for attaching the tracking device to an article to be shipped or another object). FIG. 5A is an example top-down, view of a plurality of tracking devices 500, 580, 582, 584 which may be configured the same as or similarly to any of the tracking devices 102, 104, 410, 414 described above. In this example, the tracking device 500 is depicted in an exploded view and includes a top layer 510, beacon transmission circuitry 520, one or more batteries 530, a processor 540, and a bottom layer 550 below the top layer and beacon transmission circuitry. Tracking devices 580, 582, 584 may be configured the same or similarly to tracking device 500.

The tracking device 500, as with the tracking devices described above, may also include beacon transmission circuitry 520. In this example, the beacon transmission circuitry includes an antenna 522 and capacitor 524 which may be arranged on a flex inlay 526.

The top and bottom layers may provide impact protection, prevent the ingress of liquids and other contaminants, as well as provide a smooth surface for applying labels or on which to print information (whether or not an additional adhesive label is not used). The top layer 510 and bottom layer 550 may be a thin sheet (e.g., 0.1 mm) of polyester or paper each with an adhesive backing. In this regard, the top layer 510 may be pressed onto the bottom layer 550 with the beacon transmission circuitry 520, one or more batteries 530, and the processor 540) (and in some instances, a frame or flex inlay 526 as discussed further below) therebetween. In this regard, the beacon transmission circuitry 520, one or more batteries 530, and processor 540) are arranged between the top layer and the bottom layer. In addition, the adhesive backing on the top layer may secure the top layer to the bottom layer, and the adhesive backing on the bottom layer may be used to attach the tracking device to an object (e.g., a package). Alternatively, the bottom layer may include adhesive on opposing sides (e.g., a top side and a bottom side) of the bottom layer allowing for the attachment of the top layer onto the bottom layer without the additional adhesive. As noted above, the adhesive backing may include commercially available glues or double-sided tapes such as those provided by 3M including 3M Double Coated Tape 93015LE.

The top layer 510 may be configured to be printed on during manufacturing and/or by the end user before application of the tracking device on an object (e.g., a package, a wall, a shelf, etc.). For example, the end user may be able to print tracking and identifier information directly onto the top layer. As such, top layer 510 may be a top adhesive label with a pre-printed visual code 514. For instance, the tracking device 500 may have a visual code such as QR codes or barcodes printed on the tracking device or may include a passive RFID or a no power NFC chip, etc. which can be read by the input devices (e.g., a scanner). Alternatively, the tracking and identifier information may be printed onto a separate label and applied to a surface (e.g., the top layer) of the tracking device 500 when ready to use the tracking device.

Such labels may include proprietary labels or commercially available labels such as those provided by AVERY including the Avery Ultra Duty White Film 94211.

The beacon transmission circuitry 520 may be situated at least partially within the flex inlay 526 or a printed circuit board (PCB) (not shown) and may be connected to the one or more batteries 530 via traces. The PCB may include various features such as an identifier chip and/or a transmission device for the purposes of transmitting beacon signals. The PCB may be a commercially available PCB which can be connected to one or more batteries. For example, the PCB may include PCBs such as surface mount technology (SMT) PCBs including devices that enable BLUETOOTH LE 4.0 technology for the purposes of enabling the aforementioned beacon signals.

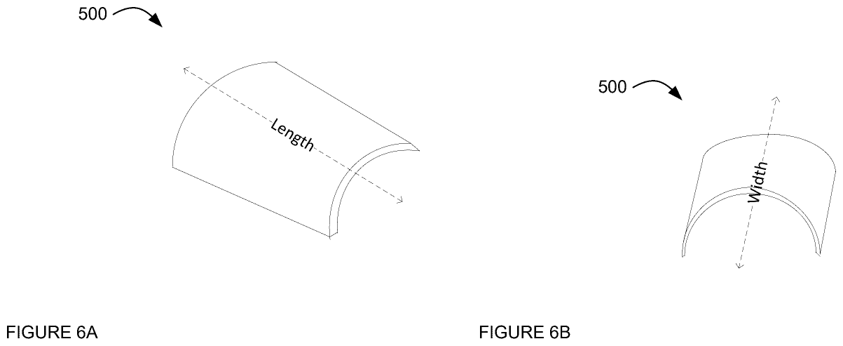

The one or more batteries 530 may be relatively thin. For example, the one or more batteries 530 may include a coin cell, prismatic, pouch, thin-film, or screen-printed battery. For example, as depicted in FIG. 5A, the one or more batteries 530 is a thin film battery. In this example, the thin film battery may be a commercially available thin-film MOLEX 13299-0002 battery. CPO042350 battery provided by RENATA BATTERIES, etc. In this regard, given the configuration of the tracking device 500, this may allow for bending along the length of the tracking device 500 as depicted in FIG. 6A as well as along the width of the tracking device 500 as depicted in FIG. 6B.

Alternatively, coin cell batteries, such as CR2016, CR1216, CR1220, CR2012, etc. may be used. Coin cell batteries are typically used in powered badges and key cards and provided various benefits such as improved safety (e.g., because of a metal encased battery with reduced puncture danger as compared to thin-film batteries). higher capacity or rather longer life for extended runtime operations, lower costs, easier storage (for example, coin cell batteries usually slot into a battery holder and thus can be stored separately and installed closer to time of use which may also allow tracking devices to be stored in facilities not rated for battery storage whereas flatpack or other custom batteries are typically bonded to the device at manufacturing), lower lead times (e.g., for manufacture and availability), and so on.

In addition, although coin cell batteries do not bend, their smaller form factor may allow for lower stiffness in the tracking device. In other words, the tracking device may be more tolerant to bending at points away from the coin cell battery whereas for a thin-film battery, bending should be avoided in order to prevent damage to the thin-film battery which may have a larger form factor. The further the rigid portions are located away from one another and the PCB, the greater the amount of flexibility that can be achieved. In this regard, given the configuration of the tracking device 500, bending along the length of the tracking device 500 as depicted in FIG. 6A may be less desirable (e.g., likely to cause damage to the rigid components) than bending along the width of the tracking device 500 as depicted in FIG. 6B.

The processor 540 may be configured the same or similarly to processors 110 and may include conventional processors, such as commercially available CPUs, MCUs, ASICs etc. or customized versions of these. For instance, the processor 540 may also include BLUETOOTH radio capabilities such as the NORDIC SEMICONDUCTOR nRF52832 or INPLAY IN100. In some instances, the processor 540) may actually comprise multiple processors that may or may not be stored within the same physical housing.

In some instances, as an alternative to the flex inlay, the tracking device may include a frame (not shown) to provide additional support to the tracking device. For example, the frame may be formed from various materials such as polycarbonates or other plastics such as cellulose fiber (paper/wood), polyethylene (PE/LDPE/HDPE), polypropylene (PP), Vinyl (PVC), Nylon, Polyurethane (foam), rubber, silicone, resin, carbon fiber. The frame may be die-cut, molded or manufactured using other processes. The materials of the frame may be selected in order to enable the frame to be strong and puncture resistant while also flexible. In this regard, the frame may enable the tracking device 500 to be attachable to objects (via the adhesive of the bottom layer 550) of various shapes including curved surfaces, such as depicted in FIGS. 6A and 6B.

In some instances, a liner sheet or liner material, such as liner material 560 of FIGS. 5A, 5B, may be used to protect the adhesive before the tracking device is attached to an object. The liner material 560 may allow adhering multiple labels to the liner material during manufacturing and may be either rolled or folded into one continuous strip of labels to feed into a printer. For instance, before using the tracking device 500 may be attached to the liner material 560 such as craft or other paper to protect the adhesive on the bottom layer of the bottom surface before use. In such instances, the tracking devices may be provided on a roll which can be run through a printer to enable printing of information on the top layer of the tracking devices. In this regard, the tracking devices 500, 580, 582, 584 of FIG. 5A may represent a small portion of a larger roll which has been unrolled. Thus, a plurality of the tracking devices may be manufactured on a roll of the liner material 560, such as a waxed paper liner or other appropriate backing, which allows the tracking devices to be printed.

When in use, each tracking device may be peeled off of the roll of liner material and applied to an article to be shipped or another object by a human operator, such as user 222. In this regard, before applying the tracking device 500 to an object, the tracking device may be removed from the liner material (e.g., peeled away) in order to expose the adhesive on the bottom surface of the bottom layer. As noted above, the tracking device may be printed on during manufacturing and/or by a human operator before removal from the liner material and application of the tracking device on a package to be shipped or another object. Thereafter the tracking device 500 may be activated (in order to initiate the beacon signals) in a normal operating mode for tracking objects as described above and attached to an object for tracking purposes.

Example Methods

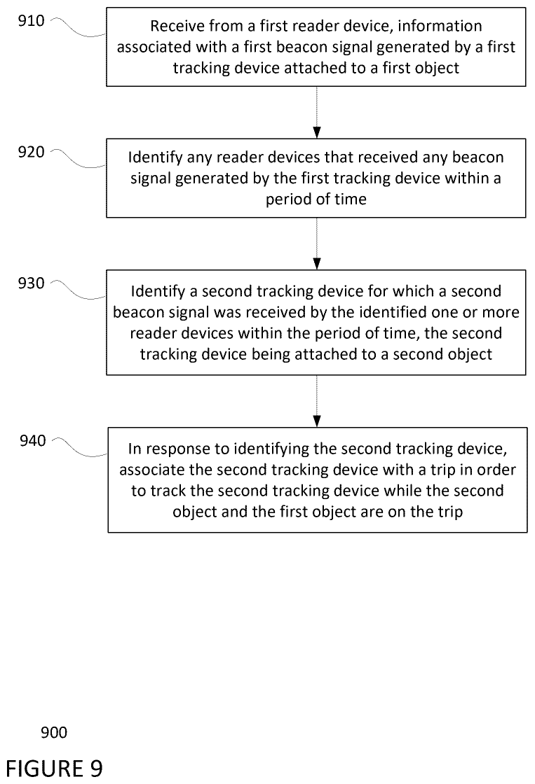

FIG. 9, is an example flow diagram 900 in accordance with some of the aspects described above that may be performed by the one or more processors 110 or the one or more server computing devices 108. While FIG. 9 show blocks in a particular order, the order may be varied and that multiple operations may be performed simultaneously. Also, operations may be added or omitted. For instance, at block 910, information associated with a first beacon signal generated by a first tracking device attached to a first object is received from a first reader device.

In some instances, an operator may scan a barcode, QR code, or other visual feature of a first tracking device in order to identify the first tracking device. The operation may then select a trip, for instance from a plurality of predefined trips, and assign that tracking device and/or its associated object to the selected trip.

Returning to FIG. 9, at block 920, one or more reader devices that received any beacon signal generated by the first tracking device within a period of time are identified. For instance, the first tracking device as well as a plurality of other tracking devices may periodically send beacon signals as described above. These may be received by one or more reader devices and information from the beacon signals may be reported or sent to and received by the one or more server computing devices 108 and stored, for example, in the storage system 250 for later retrieval and use. This information may include, for example, any sensor data, timestamps, or other messages (e.g., alerts) in the beacon signals as well as information identifying the tracking device.

As an example, the one or more server computing devices 108 may receive the information for a beacon signal of the first tracking device and associate the information with an identifier for the reader device that sent the information (the “initial reader device”). The information and the association may be stored in the storage system for later use and retrieval. In this regard, beacon signals may be indexed by timestamp, tracking device or object, sensor data, etc.

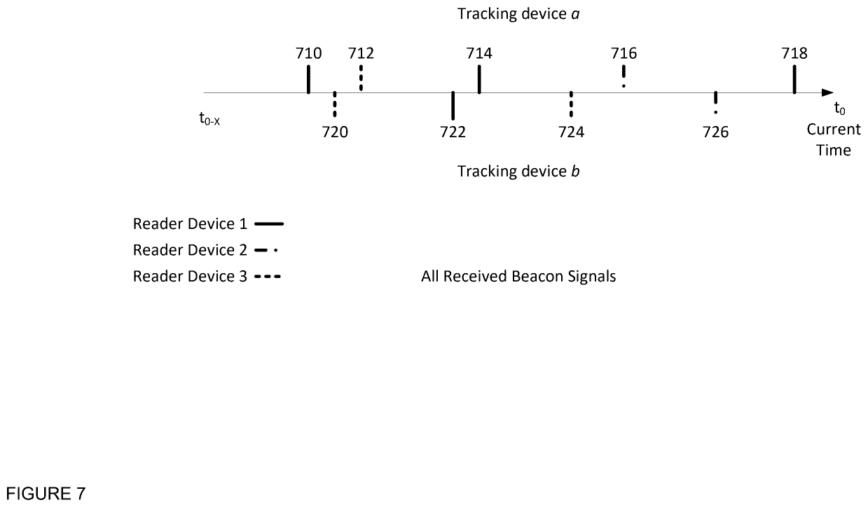

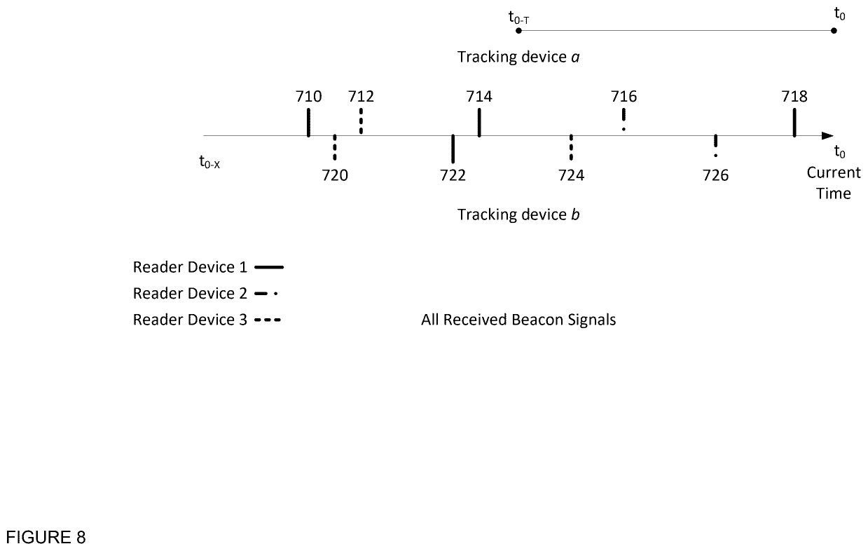

The one or more server computing devices 108 may then access the stored information (e.g., from the storage system 250) in order to identify any other beacon signals received by the reader device within a predetermined window or a period of time T. For instance, FIGS. 7 and 8 are example representations of beacon signals and associated data all or some of which may be stored in the storage system 250. Referring to FIG. 7, starting at time t₀₋ₓ and going until time t₀ (representing the current time), the one or more server computing devices 108, may identify a plurality of beacon signals generated by a tracking device a (beacon signals 710, 712, 714, 716, 718) and a plurality of beacon signals generated by a tracking device b (beacon signals 720, 722, 724, 726). The beacon signals 710, 722, 714, 718 may have been received by a Reader Device 1, signals 720, 712, 724 may have been received by a Reader Device 2, and signals 716, 726 may have been received by a Reader Device 3. Turning to FIG. 8, during the period of time starting at time t_{0-T} and going until time t₀ (representing the current time), the one or more server computing devices 108, may identify a beacon signal 718 generated by the tracking device a and received by the Reader Device 1 within the period of time T (e.g., a targeted time window between t_{0-T} and the current time t₀).

Returning to FIG. 9, at block 930, a second tracking device for which a second beacon signal was received by the identified one or more reader devices within the period of time is identified. In this example, the second tracing device is attached to a second object. For instance, for any identified reader devices, the one or more server computing devices 108 may also identify, from the data stored in the storage system 250, any other tracking devices from which those reader devices also received beacon signals within the time window. For instance, using the tracking device ID and timestamp of any received beacon signals, the one or more server computing devices 108 may identify any reader devices (including the initial reader device) that have also received a beacon signal generated by the first tracking device within the period of time T. As shown in FIG. 8, the one or more server computing devices 108, may identify that the Reader Device 2 also received beacon signal 716 generated by the first tracking device a within the period of time T. In this example, Reader Device 3 did not receive any beacon signals generated by the tracking device a within the period of time T.

Returning to FIG. 9, at block 940, in response to identifying the second tracking device, the second tracking device is associated with a trip in order to track the second tracking device while the second object and the first object are on the trip. For instance, for any other tracking devices that are identified, the one or more server computing devices 108 may automatically associate those other tracking devices and any associated objects of those tracking devices with the trip. As shown in FIG. 8, the one or more server computing devices 108, may identify that the Reader Device 2 also received beacon signal 726 generated by the tracking device b within the period of time T. In this regard, the one or more server computing devices 108 may automatically pair the tracking device b to the same trip to which the tracking device a is already paired. This relationship may be stored in the storage system 250 for tracking purposes.

If the period of time T is too long, the result may be a lot of noise, and if the period of time T is too short the result may miss some tracking devices. In this regard, in some instances, this period of time may be related to the reader device uploading interval (e.g., a multiple of). For example, if the reader device uploading or reporting interval is 5 minutes, the period of time T may be 30 minutes. Of course, greater or shorter periods of time may be used.

In addition, the same approach can be used to attach additional attributes (e.g., batch number, expiration date, color, type or category, etc.) to those other tracking devices and any associated objects of those tracking devices rather than having to do so individually. This may provide even greater reductions in overhead. In addition, a richer set of data is available at that time as well as downstream in the supply chain. For instance, these additional attributes may enable comparisons of what should be in a particular location (e.g., loaded on a truck or in a shipping container) and what actually is in that location. This may enable earlier detection of differences or shortages, which in turn, may enable a faster resolution for missing or misplaced objects. This information may also be used to provide notifications, for example, to a shipper or another party indicating that an object or shipment of objects is ready, has left, has arrived, etc. at a particular location, thereby improving inventory management and visibility.

Various approaches may also be used to reduce and potentially eliminate false positives. For instance, the one or more server computing devices 108 may only search for other reader devices and other tracking devices in certain situations. For example, when the first tracking device is first activated and/or assigned to the trip, it may still be located within a warehouse or other location at which there are other tracking devices and objects which are beaconing nearby but which are not going on the same trip. In this regard, the one or more server computing devices 108 may determine when the tracking device has left a particular geographic area, has been outside of a particular geographic area for at least some period of time or some other event has occurred, such as location has changed within a certain distance or feedback from a sensor of the tracking device indicates movement (e.g., accelerometer, gyroscope, etc.). Thereafter, once an additional beacon signal is received by a reader device, the one or more server computing devices 108 may proceed to search for other reader devices that have heard that additional signal, and so on.

In other instances, in order to reduce and potentially eliminate false positives, before assigning other tracking devices to the trip, the one or more server computing devices 108 may calculate similarity scores. As an example, a similarity score may represent a similarity between the characteristics of beacon signals of the first tracking device and beacon signals of other tracking devices. Tracking devices for which beacons are heard by the same reader device around the same time as a beacon from the first tracking device should have a higher score as compared to tracking devices for which beacons heard by the same reader device at a different time. The following is an example equation for calculation of a similarity score S between two tracking devices (tracking device a or “a” and tracking device b or “b”), though other approaches may also be used.

$$S = \frac{1}{{n}_{a} + {n}_{b}} {\sum }_{i} {\sum }_{j} {\sum }_{k} max ( 1 - \frac{\vert {t}_{ij}^{a} - {t}_{ik}^{b} \vert}{R} , 0 )$$

In this example, as noted above, t is an exact time when a particular beacon signal was emitted, a may refer to one tracking device (e.g., the first tracking device assigned to the trip), b may refer to another tracking device, i may refer to a particular reader device, j may be an index of the sequence of all beacon signals received from a within a targeted time window (e.g., the period of time T), k may be an index of the sequence of all beacon signals received from b within the same targeted time window, nₐ may be the total number of beacon signals sent by a within the targeted time window, and n_{b} may be the total number of beacon signals sent by b within the same targeted time window. R may be a constant. This constant may be selected or determined based on a reader device's scanning interval. As an example, the value of R may be two times the reader scanning interval. The equation may result in the similarity scores between two tracking devices that fall between 0 and 1 and which are also independent of the length of the targeted time window.

Tracking devices that are traveling on the same trip are likely to have very high similarity scores. In this regard, if the similarity score meets a threshold value, then the tracking device b may be paired to a trip to which the tracking device a is already paired. While the example above involves a first tracking device which is initially assigned to a trip, in some instances, this step may not occur or be possible. In such instances, the one or more server computing devices 108 may periodically process beacon signals from all tracking devices or all tracking devices that are not currently assigned to a trip. For instance, the one or more server computing devices 108 may determine when a tracking device has left a particular geographic area for at least some period of time or some other event has occurred as described above, when a beacon signal for that tracking device is received, the one or more server computing devices 108 may then identify any other reader devices that have also received the beacon signal within the predetermined period of time. Again, for any identified reader devices, the one or more server computing devices 108 may also identify any other tracking devices from which those reader devices also received beacon signals within the time window. The one or more server computing devices 108 may then calculate trajectory similarity scores between any two tracking devices as described above.

The one or more server computing devices 108 may then use a clustering algorithm to identify which tracking devices should be assigned to the same trip. In some instances, the clustering algorithm may include a modified Density-Based Spatial Clustering of Applications with Noise (DBSCAN) to cluster the similarity scores into groups. Because the distance between tracking devices should be less when similarity scores are greater, the similarity scores may be inverted before using the DBSCAN. The one or more server computing devices 108 may group together points that are closely packed based on two parameters: ‘eps’ (maximum distance) and ‘minPts’ (minimum number of points to form a dense region). The one or more server computing devices 108 may start with an arbitrary point, expanding the cluster by recursively visiting neighboring points within ‘eps’ distance until no more points can be added. Points with fewer than ‘minPts’ neighbors within ‘eps’ distance are considered as noise or outliers. The process may continue until all points have been assigned to clusters or marked as noise. For all of the tracking devices having similarity scores within a cluster may be assigned to a trip. In this regard, tracking devices with similarity scores in different clusters may be assigned to a different trip.

In some instances, a similar approach may be used to associate reader devices with a trip. For example, each time a reader device reports information, this may be stored and indexed by timestamp as if it were a beacon signal. Similarity scores between the trajectory of the reader device and first tracking device may also be calculated, for example, using the approach described above. If the similarity score meets the threshold, the reader device may be associated with the same trip. Alternatively, the similarity score may be clustered with other similarity scores and assigned to a trip as described above. This may enable the one or more server computing devices 108 to determine which reader devices are also on which trips (e.g., a reader device mounted within a truck, train, airplane, boat, etc.).

Alternatively, rather than calculating similarity scores for a reader device and a tracking device, similarity scores may be determined between two reader devices. This may also involve comparing the history of beacon signals seen by each reader device, WiFi scan history (e.g., a reader device may periodically scan for nearby WiFi SSIDs, which can be used for similarity comparison purpose as well.), GPS location history, cell tower scan history, trajectories or any types of locations generally, etc. In this regard, if the similarity score meets the threshold, one reader device may be associated with the same trip as another reader device. Alternatively, the similarity score may be clustered with other similarity scores and assigned to a trip as described above.

In some instances, once a tracking device is assigned to a trip, similarity scores may be periodically recalculated. If the similarity scores with other tracking devices paired to the same trip fall too low or if the aforementioned clustering indicates that the tracking device is no longer on the same trip as it previously was, this may cause the one or more server computing devices 108 to generate an alert. This alert may be sent to a computing device, such as client computing device 220, and provided, for example, for display to a human operator, such as user 222.

The features described herein provide for inferred pairing of objects and/or tracking devices to trips. In particular, trip pairing may be automatically inferred to improve efficiency and potentially significantly reduce manual effort. In addition, the feature described herein may provide for better and more useful inventory management as described above.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same as or similarly elements.

1. A method comprising:
receiving, by one or more processors of one or more server computing devices and from a first reader device, information associated with a first beacon signal generated by a first tracking device attached to a first object;
identifying, by the one or more processors, one or more reader devices that received any beacon signal generated by the first tracking device within a period of time;
identifying, by the one or more processors, a second tracking device for which a second beacon signal was received by the identified one or more reader devices within the period of time, the second tracing device being attached to a second object; and
in response to identifying the second tracking device, associating, by the one or more tracking devices, the second tracking device with a trip in order to track the second tracking device while the second object and the first object are on the trip.

2. The method of claim 1, wherein when the information associated with the first beacon signal is received, the first tracking device is associated with the trip, and wherein associating the second tracking device with the trip is based on the association of the first tracking device with the trip.

3. The method of claim 1, wherein the identified one or more reader devices include the first reader device and the second beacon signal is received by the first reader device.

4. The method of claim 1, wherein the second beacon signal is received by a reader device other than the first reader device.

5. The method of claim 1, further comprising, determining when the first tracking device has left a geographic area, and wherein identifying the identified one or more reader devices is in response to determining that the first object has left the geographic area.

6. The method of claim 1, further comprising, determining when the first tracking device been outside of a geographic area for at least a second period of time, and wherein identifying the identified one or more reader devices is in response to determining that the first object has been outside of a geographic area for at least a second period of time.

7. The method of claim 1, further comprising, in response to identifying the second tracking device, determining a similarity score for the second tracking device and the first tracking device, and wherein associating the second tracking device with the trip is based on the similarity score.

8. The method of claim 7, wherein the similarity score is determined further based on all beacon signals generated by the first tracking device and the second tracking device received by reader devices within the period of time.

9. The method of claim 8, further comprising, associating, by the one or more tracking devices, the first tracking device with the trip based on the similarity score in order to track the first tracking device while the first object is on the trip.

10. The method of claim 7, further comprising, clustering the similarity score with other similarity scores in order to identify a plurality of tracking devices including the first tracking device and the second tracking device, and wherein associating the second tracking device with the trip includes associating each of the plurality of tracking devices with the trip.

11. A system comprising one or more server computing devices having one or more processors configured to:
receive, from a first reader device, information associated with a first beacon signal generated by a first tracking device attached to a first object;
identify one or more reader devices that received any beacon signal generated by the first tracking device within a period of time;
identify a second tracking device for which a second beacon signal was received by the identified one or more reader devices within the period of time, the second tracing device being attached to a second object; and
in response to identifying the second tracking device, associate the second tracking device with a trip in order to track the second tracking device while the second object and the first object are on the trip.

12. The system of claim 11, wherein when the information associated with the first beacon signal is received, the first tracking device is associated with the trip, and wherein the one or more processors are further configured to associate the second tracking device with the trip further based on the association of the first tracking device with the trip.

13. The system of claim 11, further comprising the identified one or more reader devices, and wherein the identified one or more reader devices include the first reader device, and wherein the first reader device is configured to receive the second beacon signal.

14. The system of claim 11, further comprising the first tracking device and the second tracking device.

15. The system of claim 11, wherein the one or more processors are further configured to determine when the first tracking device has left a geographic area and to identify the identified one or more reader devices in response to determining that the first object has left the geographic area.

16. The system of claim 11, wherein the one or more processors are further configured to determine when the first tracking device been outside of a geographic area for at least a second period of time, and to identify the identified one or more reader devices in response to determining that the first object has been outside of a geographic area for at least a second period of time.

17. The system of claim 11, wherein the one or more processors are further configured to, in response to identifying the second tracking device, determine a similarity score for the second tracking device and the first tracking device, and to associate the second tracking device with the trip further based on the similarity score.

18. The system of claim 17, wherein the one or more processors are further configured to determine the similarity score further based on all beacon signals generated by the first tracking device and the second tracking device received by reader devices within the period of time.

19. The system of claim 18, wherein the one or more processors are further configured to associate the first tracking device with the trip based on the similarity score in order to track the first tracking device while the first object is on the trip.

20. The system of claim 17, wherein the one or more processors are further configured to cluster the similarity score with other similarity scores in order to identify a plurality of tracking devices including the first tracking device and the second tracking device, and wherein the one or more processors are further configured to associate each of the plurality of tracking devices with the trip.
